(19) United States
(12) Patent Application Publication
(10) Pub. No.: US 2026/0085616 A1
(43) Pub. Date: Mar. 26, 2026

(54) LABYRINTH SEAL AND METHOD WITH SEPARATELY-FORMED SEAL PORTIONS

(71) Applicant: PRATT & WHITNEY CANADA CORP. (P&WC), Longueuil (CA)

(72) Inventors: Piotr CIERENIEWICZ, Rzeszów (PL); Slawomir KARBOWIAK, Zdunska Wola (PL)

(73) Assignee: PRATT & WHITNEY CANADA CORP. (P&WC), Longueuil, QC (CA)

(21) Appl. No.: 18/891,014

(22) Filed: Sep. 20, 2024

(51) Int. Cl. F01D 11/02

(52) U.S. Cl. CPC F01D 11/02; F05D 2220/323; F05D 2240/55

(57) ABSTRACT

A labyrinth seal for an aircraft engine includes a base plate for mounting to a housing, a first annular insert with a stationary seal element for attaching to the base plate, an annular base for mounting to a shaft, and second annular insert with a rotating seal element for attaching to the annular base. Each of the base plate, annular base, and the first and second inserts with the seal elements, such as fins, may be made of different materials, which allows clearances (including axial clearances) of the seal elements to be controlled more precisely and may allow reduced wear. Base elements (base plate and/or annular base) and seal elements (first and/or second annular inserts) may be respectively attached to each other by a friction fit, an adhesive, a weld, a plurality of bolts, or a plurality of rivets.

### FIELD OF THE INVENTION

The subject matter disclosed herein relates to labyrinth seals and, in particular, to a labyrinth seal and method with separately-formed seal portions such as separately formed interlocking fin sections.

### BACKGROUND OF THE INVENTION

Aircraft engines, such as gas turbine engines, typically include an engine oil system that is a complex arrangement built of various components and parts. Pressure control in a such system is a difficult task that is typically realized through the use of various solutions, including seals such as labyrinth seals.

Labyrinth seals are a type of seal wherein a plurality of grooves or fins are used to prevent leakage of pressurized fluid across an interface. The fins of a labyrinth seal may be disposed on a rotating element such as a shaft, on a stationary element such as a housing or stator, or on both in an interlocking configuration. However, a very tight clearance must exist between the fins and the running surface, and this clearance is often difficult to control due to various issues such as the properties of the materials, the machinability of the materials, and the operating conditions such as high temperature environments. The operating conditions of aircraft engines includes such high temperature environments.

The above information disclosed in this Background section is only for understanding of the background of the inventive concepts and, therefore, it may contain information that does not constitute prior art.

### SUMMARY OF THE INVENTION

The present disclosure is directed, in a first aspect, to an interlocking labyrinth seal for an aircraft engine having a housing that defines an aperture and a shaft extending along an axis of the shaft and passing through the aperture, the shaft being rotatable about the axis. The interlocking labyrinth seal includes a base plate structured to fit into the aperture of the housing to seal against an outer periphery of the aperture, the base plate further having a first opening dimensioned to extend along the axis of the shaft when the base plate is fitted into the aperture of the housing. A first annular insert is structured to fit in a sealing relationship to the first opening of the base plate and having a second opening extending around the axis of the shaft when the base plate is fitted into the aperture of the housing, the first annular insert having fins disposed adjacent the second opening. An annular base has a third opening dimensioned to fit onto the shaft to define a sealed interface between the annular base and the shaft, and a second annular insert has a fourth opening extending around the axis of the shaft when the annular base is fitted to the shaft. The fourth opening is structured to fit in a sealing relationship to an outer periphery of the annular base and has fins extending adjacent an outer diameter of the second annular insert and structured to engage the fins of the second annular insert such that: the second annular insert is rotatable around the axis of the shaft relative to the base plate when the base plate is fitted into the aperture of the housing, and the fins of the first annular insert and the fins of the second annular insert form a sealed rotational interface therebetween.

In an embodiment, the base plate may include a sleeve structured to be friction fit into the aperture of the housing.

In another embodiment, the base plate and first annular insert may include materials having different compositions and/or the annular base and second annular insert may include materials having different compositions.

In a further embodiment, the materials having different compositions may include an aluminum and a steel, a first and a second alloy or grade of aluminum, a first and a second alloy or grade of steel, an aluminum and a high-temperature polyimide, a steel and a high-temperature polyimide, or a first and a second high-temperature polyimide.

In yet another embodiment, the base plate and first annular insert and/or the annular base and second annular insert may be respectively attached to each other by a friction fit, an adhesive, a weld, a plurality of bolts, or a plurality of rivets.

In an embodiment, the first annular insert and the second annular insert may include materials having different compositions.

In another embodiment, the materials having different compositions may include an aluminum and a steel, a first and a second alloy or grade of aluminum, a first and a second alloy or grade of steel, an aluminum and a high-temperature polyimide, a steel and a high-temperature polyimide, or a first and a second high-temperature polyimide.

In a further embodiment, the interlocking labyrinth seal may further include a threaded nut for securing the annular base to the shaft.

The present disclosure is also directed, in a second aspect, to a method of providing an interlocking labyrinth seal for an aircraft engine having a housing that defines an aperture and a shaft extending along an axis of the shaft and passing through the aperture, the shaft being rotatable about the axis. The method includes attaching a base plate to the housing to form a seal against an outer periphery of the aperture in the housing, the base plate having a first opening with a first inner diameter, attaching a first annular insert to the base, the first annular insert having a first outer diameter disposed in a sealed relationship with the first inner diameter and further including a first plurality of fins disposed at a seal position, attaching an annular base onto the shaft extending through the aperture in the housing, the annular base having a second outer diameter, and attaching a second annular insert to the annular base, the second annular base having a second inner diameter disposed in a sealed relationship with the second outer diameter and further including a second plurality of fins disposed at the seal position to interlock with the first plurality of fins and form a sealed rotational interface.

In an embodiment of the method, attaching the base plate to the housing may include friction fitting a sleeve of the base plate into the aperture of the housing.

In another embodiment, the method may further include selecting the base plate and first annular insert to include materials having different compositions and/or selecting the annular base and second annular inset to include materials having different compositions.

In a further embodiment of the method, the materials having different compositions may include an aluminum and a steel, a first and a second alloy or grade of aluminum, a first and a second alloy or grade of steel, an aluminum and a high-temperature polyimide, a steel and a high-temperature polyimide, or a first and a second high-temperature polyimide.

In yet another embodiment of the method, attaching the base plate to the first annular insert and/or attaching the annular base to the second annular insert may include fastening by: friction fitting, adhesive bonding, welding, a plurality of bolts, or a plurality of rivets.

In an embodiment, the method may further include selecting the first annular insert and the second annular insert to have materials with different compositions.

In another embodiment of the method, the materials having different compositions may include an aluminum and a steel, a first and a second alloy or grade of aluminum, a first and a second alloy or grade of steel, an aluminum and a high-temperature polyimide, a steel and a high-temperature polyimide, or a first and a second high-temperature polyimide.

In a further embodiment of the method, attaching the annular base to the shaft may further include securing a threaded nut to the shaft adjacent the annular base.

The present disclosure is further directed, in a third aspect, to a labyrinth seal for an aircraft engine having a housing that defines an aperture and a shaft extending along an axis of the shaft and passing through the aperture, the shaft being rotatable about the axis. The labyrinth seal includes a base plate having a sleeve structured to fit into the aperture of the housing, the base plate formed of a first composition of material and having a first opening with a first inner diameter, and a first annular insert, the first annular insert formed of a second composition of material different from the first composition of material and having a first outer diameter structured to form a sealed interface with the first inner diameter and further including a first labyrinth seal element disposed at a seal position. The labyrinth seal further includes an annular base structured to fit onto the shaft extending through the aperture in the housing, the annular base formed of a third composition of material and having a second outer diameter, and a second annular insert, the second annular insert formed of a fourth composition of material different from the third composition of material and having a second inner diameter structured to form a sealed interface with the second outer diameter and further including a second labyrinth seal element disposed at the seal position to interface with the first labyrinth seal element and form a sealed rotational interface.

In an embodiment of the labyrinth seal, a combination of the first and second compositions of material and/or the third and fourth compositions of material may include a combination of an aluminum and a steel, a first and a second alloy or grade of aluminum, a first and a second alloy or grade of steel, an aluminum and a high-temperature polyimide, a steel and a high-temperature polyimide, or a first and a second high-temperature polyimide.

In another embodiment of the labyrinth seal, a combination of the second and fourth compositions of material of the first and second labyrinth seal elements may include a combination of an aluminum and a steel, a first and a second alloy or grade of aluminum, a first and a second alloy or grade of steel, an aluminum and a high-temperature polyimide, a steel and a high-temperature polyimide, or a first and a second high-temperature polyimide.

In a further embodiment of the labyrinth seal, at least one of the first and second labyrinth seal elements comprise fins.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 is a perspective cross-sectional view of a labyrinth seal in accordance with the present disclosure;

FIG. 2 is a close-up perspective view of a first embodiment of a connection interface in accordance with the present disclosure;

FIG. 3 is a close-up perspective view of a second embodiment of a connection interface in accordance with the present disclosure;

FIG. 4 is a close-up perspective view of a third embodiment of a connection interface in accordance with the present disclosure;

FIG. 5 is a close-up perspective view of a fourth embodiment of a connection interface in accordance with the present disclosure; and

FIG. 6 is a close-up perspective view of a fifth embodiment of a connection interface in accordance with the present disclosure.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art.

The following discussion omits or only briefly describes conventional features of the disclosed technology that are apparent to those skilled in the art. Reference to a particular embodiment does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. A person of ordinary skill in the art would know how to use the instant invention, in combination with routine experiments, to achieve other outcomes not specifically disclosed in the examples or the embodiments.

Unless otherwise specifically defined herein, all terms are to be given their broadest possible interpretation including meanings implied from the specification as well as meanings understood by those skilled in the art and/or as defined in dictionaries, treatises, etc. Unless defined otherwise, all technical and scientific terms used herein have the same meaning as commonly understood by one of ordinary skill in the art in the field of the disclosed technology. It must also be noted that, as used in the specification and the appended claims, the singular forms “a,” “an,” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. Additionally, methods, equipment, and materials similar or equivalent to those described herein can also be used in the practice or testing of the disclosed technology.

The devices of the present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting. All spatial references, such as, for example, proximal, distal, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior.”

It will further be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

Various examples of the disclosed technology are provided throughout this disclosure. The use of these examples is illustrative only, and in no way limits the scope and meaning of the invention or of any exemplified form. Likewise, the invention is not limited to any particular preferred embodiment(s) described herein. Indeed, modifications and variations of the invention may be apparent to those skilled in the art upon reading this specification, and can be made without departing from its spirit and scope. The invention is therefore to be limited only by the terms of the claims, along with the full scope of equivalents to which the claims are entitled.

The present disclosure is directed to a labyrinth seal that includes a stationary base plate for mounting to a housing, a stationary seal element in the form of a first annular insert for attaching to the base plate, an annular base for mounting to a shaft, and a rotating seal element in the form of a second annular insert for attaching to the annular base. Each of the base plate, the annular based and the first and second annular inserts with the seal elements, such as fins, may be made of different materials, which allows clearances (including axial clearances) of the seal elements to be controlled more precisely and may allow reduced wear. The base elements (i.e., base plate and annular base) and seal elements (first and second annular inserts) may be respectively attached to each other by an interference-fit, an adhesive, a weld, a plurality of bolts, or a plurality of rivets.

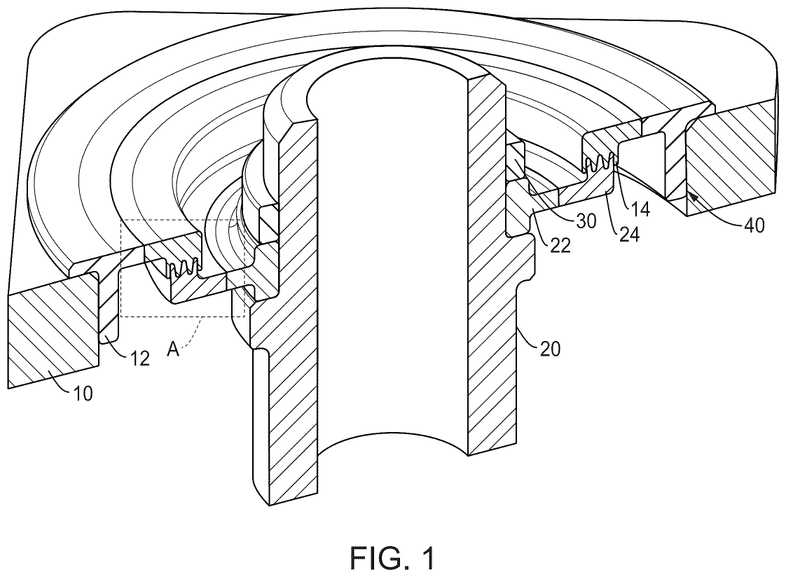

Referring to FIG. 1, an embodiment of an interlocking labyrinth seal in accordance with the present disclosure is illustrated in a cut-away cross-sectional view. Although embodiments illustrated herein relate to embodiments of interlocking labyrinth seals for an aircraft engine having a housing that defines an aperture and a shaft extending along an axis of the shaft and passing through the aperture, the shaft being rotatable about the axis, where a first set of fins interlock with an opposing set of fins, the present disclosure is not limited thereto and may further include embodiments where a first set of fins, i.e., a first labyrinth seal element, are disposed adjacent a land surface, i.e., a second labyrinth seal element, such as a land ring.

In an embodiment, an interlocking labyrinth seal may be disposed to provide a seal between a housing 10 and a rotating shaft 20 included in an aircraft engine such as a gas turbine engine. A base plate 12 of the interlocking labyrinth seal is configured for mounting to the housing 10. Typically, base plate 12 will be annular if it is fit into a circular aperture in the housing. However, the other shape apertures are possible, and the base plate 12 will be shaped to correspond to the aperture shape (circular, square, rectangular, oval, etc.). In an embodiment, the base plate 12 may be interference fit into the housing 10 such as by a friction fit (i.e., press fit, interference fit, or a shrink fit). Accordingly, the base plate 12 may have a sleeve 40 dimensioned to tightly fit within an aperture of the housing 10 and a flange portion that positions the base plate 12 against the housing 10. The base plate 12 further includes a first opening having a first inner diameter.

The first inner diameter of the base plate 12 is dimensioned to fit a first labyrinth seal element. In the present embodiment of an interlocking labyrinth seal, the first labyrinth seal element is a first annular insert 14. The first annular insert 14 includes a first outer diameter corresponding to the first inner diameter so as to fit against and be mounted to the base plate 12. The first annular insert 14 further includes a first plurality of fins disposed at a seal position at an inner portion thereof adjacent a second opening.

An annular base 22 of the interlocking labyrinth seal is configured for mounting on the shaft 20. For example, the shaft 20 may include a collar and the annular base 22 may have a third opening to fit over the shaft 20 and be positioned against the collar. In an embodiment, a threaded nut or other fastener may be secured against the annular base 22 opposite the collar to affix the annular base to the shaft 20. For example, in an embodiment, the annular base 22 may include the third opening having a third inner diameter corresponding to a diameter of the shaft 20, and the interlocking labyrinth seal may further include a threaded nut 30 for securing the annular base 22 to the shaft 20. The annular base 22 further includes a second outer diameter. The second outer diameter may be smaller than a diameter of the seal position so as to allow space for a second labyrinth seal element.

In this interlocking labyrinth seal embodiment, the second labyrinth seal element is a second annular insert 24. The second annular insert 24 includes a second inner diameter corresponding to the second outer diameter of the annular base 22 so as to fit against and be mounted to the annular base 22. The second annular insert 24 includes a second plurality of fins disposed at the seal position adjacent a fourth opening to interlock with the first plurality of fins to form a seal.

By providing the base plate 12, the first annular insert 14, the annular base 22, and the second annular insert 24 as separate elements, these components may comprise materials having different compositions and may further allow for the replacement of fin sections 14 and/or 24 as they wear out without the need to replace base sections 12 and/or 22.

For example, the base plate 12 and first annular insert 14 may be formed of materials having different compositions, the annular base 22 and second annular insert 24 may be formed of materials having different compositions, and the first annular insert 14 and the second annular insert 24 may be formed of materials having different compositions.

In various applications, the materials of the base plate 12, annular base 22, and the first and second annular inserts 14, 24 having different compositions may include, for example, an aluminum and a steel, a magnesium and a steel, a magnesium and an aluminum, a first and a second alloy or grade of aluminum, a first and a second alloy or grade of magnesium, a first and a second alloy or grade of steel, an aluminum and a high-temperature polyimide, a steel and a high-temperature polyimide, a magnesium and a high-temperature polyimide, or a first and a second high-temperature polyimide.

Further, dependent upon the material compositions selected for the various combinations of base plate 12, annular base 22, and first and second annular inserts 14, 24, respectively, the attachment mechanism between base plate 12 and first annular insert 14 and/or between annular base 22 and second annular insert 24 may be limited.

For example, when the base plate 12 and/or annular base 22 and respective first and second annular inserts 14 and/or 24 include a first and a second alloy or grade of aluminum, a first and a second alloy or grade of magnesium, or a first and a second alloy or grade of steel, the base plat 12 and first annular insert 14 and/or the annular base 22 and second annular insert 24 may be attached to each other by welding. While this may make replacement of worn fin sections provided on the first and second annular inserts 14, 24 difficult or impossible, it permits the use of more expensive, longer-wearing, and/or more machinable alloys for the fin sections provided on first and second annular inserts 14, 24 and less expensive alloys for the base plate 12 and/or annular base 22.

However, dissimilar metals or metals in combination with high temperature polyimides cannot be welded. In such cases, the base plate 12 and/or annular base 22 and respective fin sections provided on first annular insert 14 and/or second annular insert 24 may be attached to one another using alternatives such as a friction fit (e.g., interference fit, press fit, or shrink fit), an adhesive, or a plurality of fasteners such as bolts or rivets. However, embodiments of the present disclosure are not limited thereto, and other attachments may be employed, such as screw joints and bayonet joints.

In various embodiments, different material compositions may be used for different reasons. For example, high-temperature polyimides such as those sold under the tradename Meldin® may be particularly suitable for fin sections provided on first annular insert 14 and second annular insert 24. However, it may be desirable to have the base plate 12 and annular base 22 portions made from a higher durability material such as aluminum, magnesium, or steel. Similarly, various alloys may have different wear or machinability attributes that make them more suitable for the fin sections provided on the first and second annular inserts 14, 24, and other alloys may have cost, durability, or machinability attributes that make them more suitable for base plate 12 and annular base 22 portions.

Thus, in various embodiments, the base plate 12 and first annular insert 14 and/or the annular base 22 and second annular insert 24, respectively, may be attached to each other by a friction fit, an adhesive, a weld, a plurality of bolts, or a plurality of rivets, and the choice thereof may depend upon the material compositions used for the various components.

In one or more embodiments, the first annular insert 14 and the second annular insert 24 may include materials having different compositions. In one or more embodiments the materials of fin sections provided on the first annular insert 14 and the second annular insert 24 having different compositions may include an aluminum and a steel, a magnesium and a steel, a magnesium and an aluminum, a first and a second alloy or grade of aluminum, a first and a second alloy or grade of magnesium, a first and a second alloy or grade of steel, an aluminum and a high-temperature polyimide, a steel and a high-temperature polyimide, a magnesium and a high temperature polyimide, or a first and a second high-temperature polyimide.

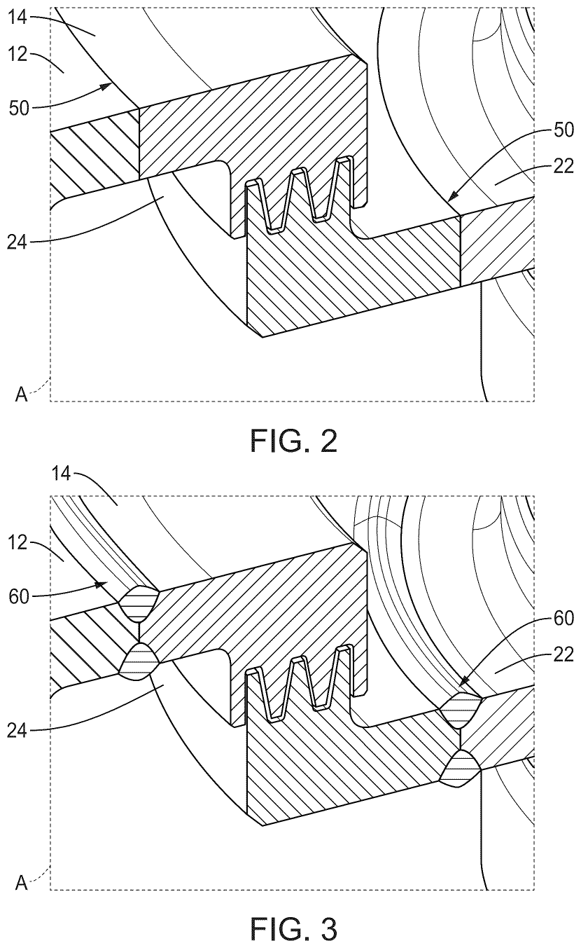

Referring to FIG. 2, a close-up of a first embodiment of section A of FIG. 1 is disclosed, wherein a friction fit 50 is used to attach base plate 12 to first annular insert 14 and to attach annular base 22 to second annular insert 24. For example, friction fit 50 may be produced by a press fit, an interference fit, or a shrink fit. In certain cases, a shrink fit, for example, may permit worn fin sections provided on the first annular insert 14 and/or the second annular insert 24 to be replaced.

Referring to FIG. 3, a close-up of a second embodiment of section A of FIG. 1 is disclosed, wherein a welded joint or weld 60 is used to attach base plate 12 to first annular insert 14 and to attach annular base 22 to second annular insert 24. Depending upon the material, weld 60 may be a brazed joint (soldered), a plurality of spot welds, or a bead weld produced by any suitable means. In certain cases, a plurality of spot welds, for example, may permit worn fin sections of the first annular insert 14 and/or the second annular insert 24 to be replaced.

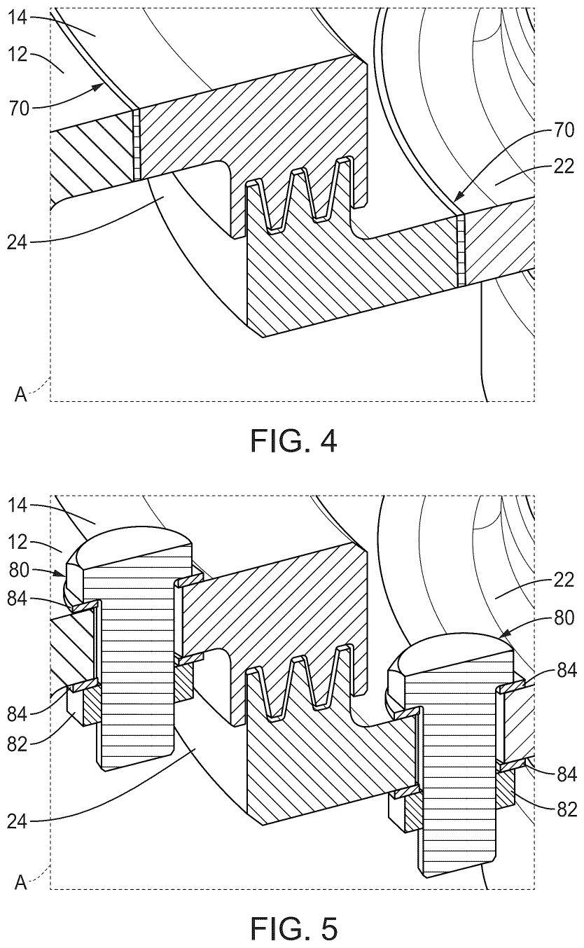

Referring to FIG. 4, a close-up of a third embodiment of section A of FIG. 1 is disclosed, wherein an adhesive joint or adhesive 70 is used to attach base plate 12 to first annular insert 14 and to attach annular base 22 to second annular insert 24. Any suitable high-temperature adhesive that is compatible with the selected material compositions may be used, including but not limited to epoxy, cyanoacrylate, and the like. In certain cases, a suitable adhesive solvent may permit worn fin sections of the first annular insert 14 and/or the second annular insert 24 to be replaced.

Referring to FIG. 5, a close-up of a fourth embodiment of section A of FIG. 1 is disclosed, wherein a plurality of bolts 80 is used to attach base plate 12 to first annular insert 14 and to attach annular base 22 to second annular insert 24. The bolts 80 may pass through holes formed by/through base plate 12 and fin section 14 and holes formed by/through annular base 22 and second annular insert 24. Each bolt 80 may also pass through respective washers 84 and be secured by respective nuts 82. When bolted together, worn fin sections of the first annular insert 14 and/or the second annular insert 24 may be replaced.

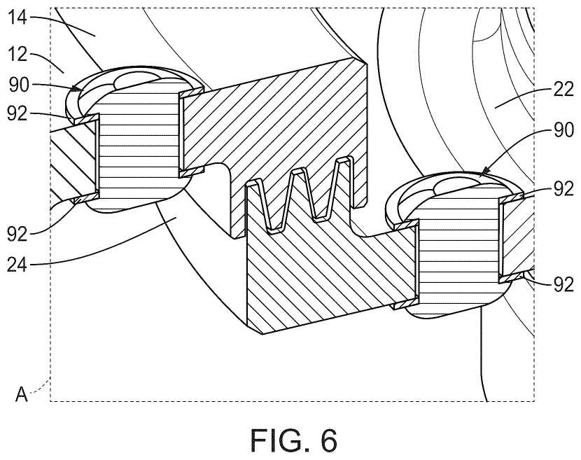

Referring to FIG. 6, a close-up of a fifth embodiment of section A of FIG. 1 is disclosed, wherein a plurality of rivets 90 is used to attach base plate 12 to first annular insert 14 and to attach annular base 22 to second annular insert 24. The rivets 90 may pass through holes formed by/through base plate 12 and fin section 14 and holes formed by/through annular base 22 and second annular insert 24. Each rivet 90 may also pass through respective washers 92. In certain cases, rivets may be drilled out to permit worn fin sections of the first annular insert 14 and/or the second annular insert 24 to be replaced.

In one or more embodiments, the present disclosure is drawn to a method of providing an interlocking labyrinth seal. Referring to FIG. 1, the method includes attaching a base plate 12 to a housing 10, the base plate 12 having a first opening with a first inner diameter. In an embodiment, attaching the base plate 12 to the housing 10 includes interference fitting the base plate 12 into an aperture in the housing 10, such as by a friction fit (e.g., press fit, interference fit, or shrink fit).

The method further includes attaching a first annular insert 14 to the base plate 12, the first annular insert 14 having a first outer diameter corresponding to the first inner diameter and a first plurality of fins disposed at a seal position.

The method also includes attaching an annular base 22 onto a shaft 20 extending through the housing 10, the annular base 22 having a second outer diameter, as well as attaching a second annular insert 24 to the annular base 22, the second annular insert 24 having a second inner diameter corresponding to the second outer diameter and a second plurality of fins disposed at the seal position to interlock with the first plurality of fins. The order of the attaching steps may vary and/or may be performed simultaneously without departing from the scope of the method.

In various embodiments, the method may further provide for selecting the base plate 12 and first annular insert 14 to include materials having different compositions and/or selecting the annular base 22 and second annular insert 24 to include materials having different compositions. As with the apparatus discussed above, the materials having different compositions in the method may include an aluminum and a steel, a magnesium and a steel, a magnesium and an aluminum, a first and a second alloy or grade of aluminum, a first and a second alloy or grade of magnesium, a first and a second alloy or grade of steel, an aluminum and a high-temperature polyimide, a steel and a high-temperature polyimide, a magnesium and a high temperature polyimide, or a first and a second high-temperature polyimide.

In an embodiment of the method, attaching the base plate 12 to the first annular insert 14 and/or attaching the annular base 22 to the second annular insert 24 may include fastening by: interference-fitting, adhesive bonding, welding, a plurality of bolts, or a plurality of rivets. Embodiments of the method may further include selecting the first annular insert 14 and the second annular insert 24 to include materials having different compositions, wherein the materials having different compositions may include an aluminum and a steel, a magnesium and a steel, a magnesium and an aluminum, a first and a second alloy or grade of aluminum, a first and a second alloy or grade of magnesium, a first and a second alloy or grade of steel, an aluminum and a high-temperature polyimide, a steel and a high-temperature polyimide, a magnesium and a high temperature polyimide, or a first and a second high-temperature polyimide.

In an embodiment wherein the annular base 22 includes a third opening having a third inner diameter corresponding to a diameter of the shaft 20, the method may further include attaching the annular base 22 to the shaft 20 by securing a threaded nut 30 to the shaft 20 adjacent the annular base 22.

Referring to FIG. 1, one or more embodiments of the present disclosure may be drawn to labyrinth seal beyond those of the interlocking type. In such an embodiment, the labyrinth seal may include a base plate 12 that is configured for mounting to a housing 10, the base plate 12 being formed of a first composition of material and having a first opening with a first inner diameter.

A first annular insert 14 with a first labyrinth seal element is attached to the base plate 12, the first annular insert 14 being formed of a second composition of material different from the first composition of material. The first annular insert 14 has a first outer diameter corresponding to the first inner diameter and the first labyrinth seal element disposed at a seal position.

The labyrinth seal of this embodiment also includes an annular base 22 configured for mounting on a shaft 20, the annular base 22 being formed of a third composition of material and having a second outer diameter. A second annular insert 24 with a second labyrinth seal element is connected to the annular base 22, the second annular insert 24 being formed of a fourth composition of material different from the third composition of material. The second annular insert 24 has a second inner diameter corresponding to the second outer diameter and the second labyrinth seal element is disposed at the seal position to interface with the first labyrinth seal element.

In one or more embodiments of the labyrinth seal, a combination of the first and second compositions of material and/or the third and fourth compositions of material may include a combination of an aluminum and a steel, a magnesium and a steel, a magnesium and an aluminum, a first and a second alloy or grade of aluminum, a first and a second alloy or grade of magnesium, a first and a second alloy or grade of steel, an aluminum and a high-temperature polyimide, a steel and a high-temperature polyimide, a magnesium and a high temperature polyimide, or a first and a second high-temperature polyimide.

In further embodiments of the labyrinth seal, a combination of the second and fourth compositions of material of the first and second labyrinth seal elements may include a combination of an aluminum and a steel, a magnesium and a steel, a magnesium and an aluminum, a first and a second alloy or grade of aluminum, a first and a second alloy or grade of magnesium, a first and a second alloy or grade of steel, an aluminum and a high-temperature polyimide, a steel and a high-temperature polyimide, a magnesium and a high temperature polyimide, or a first and a second high-temperature polyimide.

Embodiments of the labyrinth seal include those wherein one of the first and second labyrinth seal elements includes fins that abut or are adjacent to the other seal element in the form of a land surface, as well as those wherein both the first and second labyrinth seal elements comprise fins that interlock.

Labyrinth seals in accordance with the present disclosure permit the use of different material compositions for the base plate 12/annular base 22 and the fin sections of the first annular insert 14/second annular insert 24 as well as the use of different material compositions for stationary seal/fin section of first annular insert 14 and the rotating seal/fin section of second annular insert 24. Such control over the materials used allows clearances (including axial clearances) of the seal elements (e.g., fins) to be controlled more precisely and may allow reduced wear. For example, one of fin sections of the seal provided by first annular insert 14 and/or second annular insert 24 may be made of stronger/harder material than the other, allowing one fin section of the seal provided by first annular insert 14 and/or second annular insert 24 to wear grooves into the other and adjust the labyrinth shape (e.g., adjust shape of first annular insert 14) to achieve improved sealing efficiency.

In many embodiments, after base plate 12 and annular base 22 have been installed, the fin sections of the seal provided by first annular insert 14 and/or second annular insert 24 may be replaced when worn without the need to remove the base plate 12 and/or annular base 22.

Although described herein with respect to an interlocking labyrinth seal for an aircraft engine, embodiments within the present disclosure may include labyrinth seals with fins that do not interlock opposing fins as well as labyrinth seals used in applications outside of aircraft engines.

For example, an embodiment of the present disclosure may be drawn to an interlocking labyrinth seal for sealing a shaft relative to a housing that defines an aperture, the shaft extending along an axis of the shaft and passing through the aperture, the shaft being rotatable about the axis, wherein the seal includes a base plate structured to fit into the aperture of the housing to seal against an outer periphery of the aperture, the base plate further having a first opening dimensioned to extend along the axis of the shaft when the base plate is fitted into the aperture of the housing. A first annular insert is structured to fit in a sealing relationship to the first opening of the base plate and having a second opening extending around the axis of the shaft when the base plate is fitted into the aperture of the housing, the first annular insert having fins disposed adjacent the second opening. An annular base has a third opening dimensioned to fit onto the shaft to define a sealed interface between the annular base and the shaft, and a second annular insert has a fourth opening extending around the axis of the shaft when the annular base is fitted to the shaft. The fourth opening is structured to fit in a sealing relationship to an outer periphery of the annular base and has fins extending adjacent an outer diameter of the second annular insert and structured to engage the fins of the second annular insert such that: the second annular insert is rotatable around the axis of the shaft relative to the base plate when the base plate is fitted into the aperture of the housing, and the fins of the first annular insert and the fins of the second annular insert form a sealed rotational interface therebetween.

In an embodiment, the base plate may include a sleeve structured to be friction fit into the aperture of the housing.

In another embodiment, the base plate and first annular insert may include materials having different compositions and/or the annular base and second annular insert may include materials having different compositions.

In a further embodiment, the materials having different compositions may include an aluminum and a steel, a first and a second alloy or grade of aluminum, a first and a second alloy or grade of steel, an aluminum and a high-temperature polyimide, a steel and a high-temperature polyimide, or a first and a second high-temperature polyimide.

In yet another embodiment, the base plate and first annular insert and/or the annular base and second annular insert may be respectively attached to each other by a friction fit, an adhesive, a weld, a plurality of bolts, or a plurality of rivets.

In an embodiment, the first annular insert and the second annular insert may include materials having different compositions.

In another embodiment, the materials having different compositions may include an aluminum and a steel, a first and a second alloy or grade of aluminum, a first and a second alloy or grade of steel, an aluminum and a high-temperature polyimide, a steel and a high-temperature polyimide, or a first and a second high-temperature polyimide.

In a further embodiment, the interlocking labyrinth seal may further include a threaded nut for securing the annular base to the shaft.

Another embodiment of the present disclosure may be drawn to a method of providing an interlocking labyrinth seal between a housing having an aperture and a rotating shaft extending through the aperture, wherein the method includes attaching a base plate to the housing to form a seal against an outer periphery of the aperture in the housing, the base plate having a first opening with a first inner diameter, attaching a first annular insert to the base, the first annular insert having a first outer diameter disposed in a sealed relationship with the first inner diameter and further including a first plurality of fins disposed at a seal position, attaching an annular base onto the shaft extending through the aperture in the housing, the annular base having a second outer diameter, and attaching a second annular insert to the annular base, the second annular base having a second inner diameter disposed in a sealed relationship with the second outer diameter and further including a second plurality of fins disposed at the seal position to interlock with the first plurality of fins and form a sealed rotational interface.

In an embodiment of the method, attaching the base plate to the housing may include friction fitting a sleeve of the base plate into the aperture of the housing.

In another embodiment, the method may further include selecting the base plate and first annular insert to include materials having different compositions and/or selecting the annular base and second annular inset to include materials having different compositions.

In a further embodiment of the method, the materials having different compositions may include an aluminum and a steel, a first and a second alloy or grade of aluminum, a first and a second alloy or grade of steel, an aluminum and a high-temperature polyimide, a steel and a high-temperature polyimide, or a first and a second high-temperature polyimide.

In yet another embodiment of the method, attaching the base plate to the first annular insert and/or attaching the annular base to the second annular insert may include fastening by: friction fitting, adhesive bonding, welding, a plurality of bolts, or a plurality of rivets.

In an embodiment, the method may further include selecting the first annular insert and the second annular insert to have materials with different compositions.

In another embodiment of the method, the materials having different compositions may include an aluminum and a steel, a first and a second alloy or grade of aluminum, a first and a second alloy or grade of steel, an aluminum and a high-temperature polyimide, a steel and a high-temperature polyimide, or a first and a second high-temperature polyimide.

In a further embodiment of the method, attaching the annular base to the shaft may further include securing a threaded nut to the shaft adjacent the annular base.

A further embodiment in accordance with the present disclosure may be drawn to a labyrinth that includes a base plate having a sleeve structured to fit into an aperture of a housing, the base plate formed of a first composition of material and having a first opening with a first inner diameter, and a first annular insert, the first annular insert formed of a second composition of material different from the first composition of material and having a first outer diameter structured to form a sealed interface with the first inner diameter and further including a first labyrinth seal element disposed at a seal position. The labyrinth seal further includes an annular base structured to fit onto a shaft extending through the aperture in the housing, the annular base formed of a third composition of material and having a second outer diameter, and a second annular insert, the second annular insert formed of a fourth composition of material different from the third composition of material and having a second inner diameter structured to form a sealed interface with the second outer diameter and further including a second labyrinth seal element disposed at the seal position to interface with the first labyrinth seal element and form a sealed rotational interface.

In an embodiment of the labyrinth seal, a combination of the first and second compositions of material and/or the third and fourth compositions of material may include a combination of an aluminum and a steel, a first and a second alloy or grade of aluminum, a first and a second alloy or grade of steel, an aluminum and a high-temperature polyimide, a steel and a high-temperature polyimide, or a first and a second high-temperature polyimide.

In another embodiment of the labyrinth seal, a combination of the second and fourth compositions of material of the first and second labyrinth seal elements may include a combination of an aluminum and a steel, a first and a second alloy or grade of aluminum, a first and a second alloy or grade of steel, an aluminum and a high-temperature polyimide, a steel and a high-temperature polyimide, or a first and a second high-temperature polyimide.

In a further embodiment of the labyrinth seal, at least one of the first and second labyrinth seal elements comprise fins.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. An interlocking labyrinth seal for an aircraft engine having a housing that defines an aperture and a shaft extending along an axis of the shaft and passing through the aperture, the shaft being rotatable about the axis, comprising:
a base plate structured to fit into the aperture of the housing to seal against an outer periphery of the aperture, the base plate further having a first opening dimensioned to extend along the axis of the shaft when the base plate is fitted into the aperture of the housing;
a first annular insert structured to fit in a sealing relationship to the first opening of the base plate and having a second opening extending around the axis of the shaft when the base plate is fitted into the aperture of the housing, the first annular insert having fins disposed adjacent the second opening;
an annular base having a third opening dimensioned to fit onto the shaft to define a sealed interface between the annular base and the shaft; and
a second annular insert having a fourth opening extending around the axis of the shaft when the annular base is fitted to the shaft, the fourth opening structured to fit in a sealing relationship to an outer periphery of the annular base and having fins extending adjacent an outer diameter of the second annular insert and structured to engage the fins of the second annular insert such that:
the second annular insert is rotatable around the axis of the shaft relative to the base plate when the base plate is fitted into the aperture of the housing, and
the fins of the first annular insert and the fins of the second annular insert form a sealed rotational interface therebetween.

2. The interlocking labyrinth seal of claim 1, wherein the base plate includes a sleeve structured to be friction fit into the aperture of the housing.

3. The interlocking labyrinth seal of claim 1, wherein the base plate and first annular insert comprise materials having different compositions and/or the annular base and second annular insert comprise materials having different compositions.

4. The interlocking labyrinth seal of claim 3, wherein the materials having different compositions include an aluminum and a steel, a first and a second alloy or grade of aluminum, a first and a second alloy or grade of steel, an aluminum and a high-temperature polyimide, a steel and a high-temperature polyimide, or a first and a second high-temperature polyimide.

5. The interlocking labyrinth seal of claim 3, wherein the base plate and first annular insert and/or the annular base and second annular insert are respectively attached to each other by a friction fit, an adhesive, a weld, a plurality of bolts, or a plurality of rivets.

6. The interlocking labyrinth seal of claim 1, wherein the first annular insert and the second annular insert comprise materials having different compositions.

7. The interlocking labyrinth seal of claim 6, wherein the materials having different compositions include an aluminum and a steel, a first and a second alloy or grade of aluminum, a first and a second alloy or grade of steel, an aluminum and a high-temperature polyimide, a steel and a high-temperature polyimide, or a first and a second high-temperature polyimide.

8. The interlocking labyrinth seal of claim 1, wherein the interlocking labyrinth seal further includes a threaded nut for securing the annular base to the shaft.

9. A method of providing an interlocking labyrinth seal for an aircraft engine having a housing that defines an aperture and a shaft extending along an axis of the shaft and passing through the aperture, the shaft being rotatable about the axis, comprising:
attaching a base plate to the housing to form a seal against an outer periphery of the aperture in the housing, the base plate having a first opening with a first inner diameter;
attaching a first annular insert to the base, the first annular insert having a first outer diameter disposed in a sealed relationship with the first inner diameter and further including a first plurality of fins disposed at a seal position;
attaching an annular base onto the shaft extending through the aperture in the housing, the annular base having a second outer diameter; and
attaching a second annular insert to the annular base, the second annular base having a second inner diameter disposed in a sealed relationship with the second outer diameter and further including a second plurality of fins disposed at the seal position to interlock with the first plurality of fins and form a sealed rotational interface.

10. The method of claim 9, wherein attaching the base plate to the housing includes friction fitting a sleeve of the base plate into the aperture of the housing.

11. The method of claim 9, further comprising selecting the base plate and first annular insert to comprise materials having different compositions and/or selecting the annular base and second annular inset to comprise materials having different compositions.

12. The method of claim 11, wherein the materials having different compositions include an aluminum and a steel, a first and a second alloy or grade of aluminum, a first and a second alloy or grade of steel, an aluminum and a high-temperature polyimide, a steel and a high-temperature polyimide, or a first and a second high-temperature polyimide.

13. The method of claim 9, wherein attaching the base plate to the first annular insert and/or attaching the annular base to the second annular insert includes fastening by: friction fitting, adhesive bonding, welding, a plurality of bolts, or a plurality of rivets.

14. The method of claim 9, further comprising selecting the first annular insert and the second annular insert to comprise materials having different compositions.

15. The method of claim 14, wherein the materials having different compositions include an aluminum and a steel, a first and a second alloy or grade of aluminum, a first and a second alloy or grade of steel, an aluminum and a high-temperature polyimide, a steel and a high-temperature polyimide, or a first and a second high-temperature polyimide.

16. The method of claim 9, wherein attaching the annular base to the shaft further comprises securing a threaded nut to the shaft adjacent the annular base.

17. A labyrinth seal for an aircraft engine having a housing that defines an aperture and a shaft extending along an axis of the shaft and passing through the aperture, the shaft being rotatable about the axis, comprising:
a base plate having a sleeve structured to fit into the aperture of the housing, the base plate formed of a first composition of material and having a first opening with a first inner diameter;
a first annular insert, the first annular insert formed of a second composition of material different from the first composition of material and having a first outer diameter structured to form a sealed interface with the first inner diameter and further including a first labyrinth seal element disposed at a seal position;
an annular base structured to fit onto the shaft extending through the aperture in the housing, the annular base formed of a third composition of material and having a second outer diameter; and
a second annular insert, the second annular insert formed of a fourth composition of material different from the third composition of material and having a second inner diameter structured to form a sealed interface with the second outer diameter and further including a second labyrinth seal element disposed at the seal position to interface with the first labyrinth seal element and form a sealed rotational interface.

18. The labyrinth seal of claim 17, wherein a combination of the first and second compositions of material and/or the third and fourth compositions of material include a combination of an aluminum and a steel, a first and a second alloy or grade of aluminum, a first and a second alloy or grade of steel, an aluminum and a high-temperature polyimide, a steel and a high-temperature polyimide, or a first and a second high-temperature polyimide.

19. The labyrinth seal of claim 17, wherein a combination of the second and fourth compositions of material of the first and second labyrinth seal elements include a combination of an aluminum and a steel, a first and a second alloy or grade of aluminum, a first and a second alloy or grade of steel, an aluminum and a high-temperature polyimide, a steel and a high-temperature polyimide, or a first and a second high-temperature polyimide.

20. The labyrinth seal of claim 17, wherein at least one of the first and second labyrinth seal elements comprise fins.
